(19) United States
(12) Patent Application Publication
(10) Pub. No.: US 2025/0094186 A1
(43) Pub. Date: Mar. 20, 2025

(54) SYSTEMS AND METHODS FOR GRAPHICAL USER INTERFACE MACHINE LEARNING-BASED FRAUD DETECTION

(71) Applicant: HSBC Group Management Services Limited, London (GB)

(72) Inventors: Sivaram BALASUBRAMANIAN, Richmond (CA); Brendon GILL, Richmond (CA); Pandeti Subramanyam Raju REVANTH, Bengaluru (IN); Vasa Lakshmi SUBHASH, Hyderabad (IN); Jiong SHAN, Coquitlam (CA); Chance Si CHEN, Chaozhou (CN)

(73) Assignee: HSBC Group Management Services Limited, London (GB)

(21) Appl. No.: 18/961,048

(22) Filed: Nov. 26, 2024

(51) Int. Cl. G06F 9/451; G06Q 20/40

(52) U.S. Cl. CPC G06F 9/451; G06Q 20/4016

(57) ABSTRACT

A specific machine learning approach in combination with a specially configured graphical user interface rendering engine is proposed wherein the rendering of a graphical user interface is operated in concert with machine learning to provide additional processing time for machine learning during intermediate user interface process flows. By front-loading the analysis computing process, the additional processing time whereby the user traverses a sequence of graphical user interface pages is utilized for background processing of the primary identifier using a subroutine running one or more trained machine learning models that are refining an fraud estimation score during the additional processing time. Variations are also proposed where different variations of opportunistic machine learning processing chains are inserted into a processing chain if additional processing time is available after processing using a main machine learning processing model is completed.

### FIELD

Embodiments of the present disclosure relate to the field of computer science and machine learning, and more specifically, embodiments relate to devices, systems and methods for controlling graphical user interface elements for conducting front-loaded machine learning that operates as a continuously updated background computing process that automatically and opportunistically refines a computationally generated estimation as the user progresses through states of a graphical user interface.

### INTRODUCTION

A technical problem that arises in respect to computerized machine learning are processing delays during computation and/or classification. Machine learning models, especially more complex models having complex architectures or a higher level of dimensionality, require processing time to be able generate output data structures (e.g., logit classifications).

However, these processing times lead to delays that can impact a process flow, and it is desirable to reduce the impact of these processing times on the process flow. Conducting a validation or verification using a trained machine learning model upon verification of a transaction request as a final state in a graphical user interface journey can lead to either a delay in the user experience or an incomplete determination by the machine learning backend.

### SUMMARY

A specific machine learning approach in combination with a specially configured graphical user interface rendering engine is proposed wherein the rendering of a graphical user interface is operated in concert with machine learning to provide additional processing time for machine learning during intermediate user interface process flows. In particular, because the machine learning process functions are invoked during intermediate user interface inputs instead of during a final confirmation or message transmission, the machine learning can begin earlier to obtain additional processing time, so that either an alert or classification can be made during the traversal of other steps of the user interface flow or during final confirmation of the message transmission.

The proposed approach is configured to be embedded into an earlier non-final state (earlier referring to before a final transaction confirmation step) in a graphical user interface journey so that backend process activities are effectively front loaded as the user progresses through states of the graphical user interface before reaching a final transaction confirmation step. By front-loading the entering of the target beneficiary identifier into a form field, and then using a trained machine learning model that is configured to automatically refine an estimation as the user progresses through the states of the graphical user interface, additional computer processing time is made available to the trained machine learning model to converge towards a target classification, improving classification accuracy as more processing time/resources are available as the user is navigating various pages or inserting elements.

As different users traverse through the user interface screens at different speeds, a baseline amount of verification can be conducted, and if more time is available, additional verifications can be conducted as described in some variant embodiments herein, where, for example, different machine learning instances can be recruited for additional or deeper checking against additional databases, such as local instances for different jurisdictions. As noted herein, the level of verification of the target beneficiary identifier can be opportunistically increased as more processing time is available, and in some embodiments, may also include using a proxy controller that is configured to securely and privately connect to different machine learning instances that are walled from communicating from one another directly to conduct increasing levels of machine learning based verification if more time is available.

A corresponding input in an earlier state in the graphical user interface journey can be a drop-down, an interactive text box interactive visual interface element where the user can control an input device, such as a keyboard or if using mobile, capacitive touch keyboard to enter an alias or other identifier of a target beneficiary. This alias or identifier, for example, in the context of an applied use case for blockchains and/or distributed ledgers and corresponding digital objects, can be an email address, a wallet “address”, a name, etc. A problem with aliases is that they are prone to typographical errors (e.g., character transpositions, misspellings), they can be to suspect parties (or both where a malicious user is masquerading as another entity), or they can be simply incorrect. If a transaction is consummated to a problematic alias, a problem is that it can be difficult to reverse the transaction. Malicious entities become more sophisticated over time, and their attempts at generating malicious beneficiary aliases establishes a cybersecurity arms race against backend cybersecurity hardening approaches.

In an applied usage for a specific computing scenario, the specially configured graphical user interface rendering engine is a user interface engine that is configured to serve/host a webpage or user interface pages of a mobile application, such as an online banking or payment application. A user may be providing as an input, a string of characters or numbers that is a target intended recipient of funds. A backend machine learning model is configured to receive this string of characters or numbers for backend processing to generate a classification as to whether the recipient alias is potentially fraudulent or an erroneous entry. This is especially important for transactions where the target counterparty is an alias email address, for large value transactions, or for crypto asset transactions where the target is a cryptographic address string where even a single mis-typed character may lead to an irretrievable transaction.

This is especially useful as an approach to untangle potential cybersecurity attack vectors associated with social engineering. For example, an existing, trusted contact, may have their device or account compromised, and indicate that their “account number changed”, changing the target account number or identifier to reroute funds instead to a fraudulent account target. This can occur, for example, in cybersecurity attacks where a user's account has been taken over, their two factor authentication mechanisms being taken over by SIM card swaps, among others, and these are sophisticated attacks where even the most vigilant customers may be vulnerable to.

A machine learning engine backend is a useful mechanism as it can be trained to classify incoming target address strings as fraudulent or in error, without having to explicitly program classification rules. The machine learning engine can be trained on global transactions and a wider corpus of transaction data, and trained across business lines, or even different financial institutions, such that the trained representation can be used as a strong proxy for estimating fraudulent or erroneous changes. For example, training sets that are used for a particular customer at a particular institution can be used to generate machine learning updates, and not maintained/discarded after generating parameter updates for training to maintain customer privacy. Multiple institutions or multiple lines of business can benefit from interactions with the globally maintained trained machine learning model.

However, more complex machine learning engine backends can be slow in operation as large amounts of computing and processing power are required for processing highly complex architectures (e.g., multiple layers) or models having a large number of features. This complexity quickly scales upwards and has a proportionate impact on overall processing time for a given amount of computing resources. On the other hand, more complex models and model architectures are desirable as their machine learning accuracy and pattern recognition capabilities also scale upwards. For example, models may include LSTM type layers which are adapted improved machine learning memory.

The foregoing has outlined rather broadly the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example fraud checking process flow diagram, showing an example method for controlling a user interface to conduct a fraud check, according to some embodiments.

FIG. 2 is a block schematic diagram showing an example schematic of a proposed user interface/machine learning coupled backend engine, according to some embodiments.

FIG. 3A, FIG. 3B, FIG. 3C are example user interface pages showing example messages, according to some embodiments. FIG. 3D is an example page showing an authorization page where the classification has indicated that a particular target beneficiary address is in a classification tier where it is flagged as a potential scam.

FIG. 4 shows an example email data object that can be generated where the payload is captured in the body of the email.

FIG. 5 is an example machine learning engine backend that is trained on a corpus of incoming training data sets, according to some embodiments.

FIG. 6 is a block schematic example proxy controller that is directly coupled to one or more machine learning processing engines, each of which have local trained machine learning instances for a local jurisdiction or domain usage, according to some embodiments.

### DETAILED DESCRIPTION

A specific machine learning approach in combination with a specially configured graphical user interface rendering engine is proposed wherein the rendering of a graphical user interface is operated in concert with machine learning to provide additional processing time for machine learning during intermediate user interface process flows. The machine learning approach is practically implemented in the form of a tangible computer system, such as a computer server or a controlled set of distributed computing resources that may reside in a data center and are coupled to a message bus receiving inputs from one or more user interfaces that are rendering user interface elements that can be interacted with by a user through a user interface input device, such as a touch screen, a mouse and keyboard, among others.

The approach is a specially configured machine learning engine coupled to a graphical user interface rendering engine (e.g., one that runs based on a model-view-controller architecture backend) that “front-loads” a user input element to receive a string or numerical input corresponding to a primary identifier identifying a target beneficiary. By “front-loading” the analysis, the additional processing time whereby the user traverses a sequence of graphical user interface pages is utilized for background processing of the primary identifier using a subroutine running one or more trained machine learning models that are refining an fraud estimation score during the additional processing time.

In a proposed variant described herein, the additional processing time can also be utilized to use additional trained machine learning models in inference such that multiple levels of fraud estimation can be conducted. In another proposed variant, if the one or more trained machine learning models require more processing time (e.g., has not converged above a confidence threshold on a label), additional elements and screens may be injected into the process by the system. Other variants are described herein that use older snapshot models and other approaches to be added to a pipeline if additional time is available, so that machine learning forgetting challenges can be addressed automatically through the opportunistic usage of older snapshot models.

As described herein, when additional processing time is available opportunistically during user interface traversal, additional instances can be recruited for opportunistically increasing the robustness of analysis by chaining together a processing pipeline. In this example, different instances (Global, India, US, UK, China, etc.) can be configured for interoperation to share relevant information (whitelists of beneficiaries, blacklists of beneficiaries, IP, device fingerprints, rules, models). This information can be used making decisions for the payments sent to them or from them. This approach and architecture can help with data localization requirements in multiple countries (data belonging to that country must remain in that country), the decision making is distributed to a certain extent while also sharing pertinent information.

In some embodiments, the approach can also include load distribution where a load is shared across different instances (subject to regulatory requirements), where other instances take up the processing load when one instance fails or is overloaded. The proxy is the entry point to all the instances and will route the request for a decision to the most appropriate instance and then forward the decision back to the calling application.

In an applied usage for a specific computing scenario, the specially configured graphical user interface rendering engine is a user interface engine that is configured to serve/host a webpage or user interface pages of a mobile application, such as an online banking or payment application. A user may be providing as an input, a string of characters or numbers that is a target intended recipient of funds. A backend machine learning model is configured to receive this string of characters or numbers for backend processing to generate a classification as to whether the recipient alias is potentially fraudulent or an erroneous entry. This is especially important for transactions where the target counterparty is an alias email address, for large value transactions, or for crypto asset transactions where the target is a cryptographic address string where even a single mis-typed character may lead to an irretrievable transaction.

An improved computing system for fraud detection system is described herein that provides a specially configured fraud monitoring flow when a user is submitting a payment to an address/target, so that users can be reminded to be aware the possible fraud risk before the transaction is confirmed for processing. In particular, the user interface provides a specialized fraud monitoring mechanism that is based on beneficiary checking and machine learning checking of the payment target, along with a corpus of payment history data, which improves the accuracy of fraud detection.

In another variation, the computer processing instances can also be separated into payment types, instead of by country. The system can also be polymorphic, whereby different instances with different purposes can be opportunistically chained together to run additional types of verifications against the beneficiary identifier. For example, while the main described use case for transactions fraud monitoring, additional instances can be used for AML (Anti-Money Laundering), counter-terror financing, identifying mule accounts, creating a network of connected (fraudulent) parties, or detecting anomalies in any type of data set. This can also be used in preventing onboarding or account opening fraud by using information from external data sources and using the model to risk score applicants, by blocking fraudulent applications in the application journey itself (before they are onboarded to the bank or are able to open an account). The system is not limited to transaction fraud monitoring only.

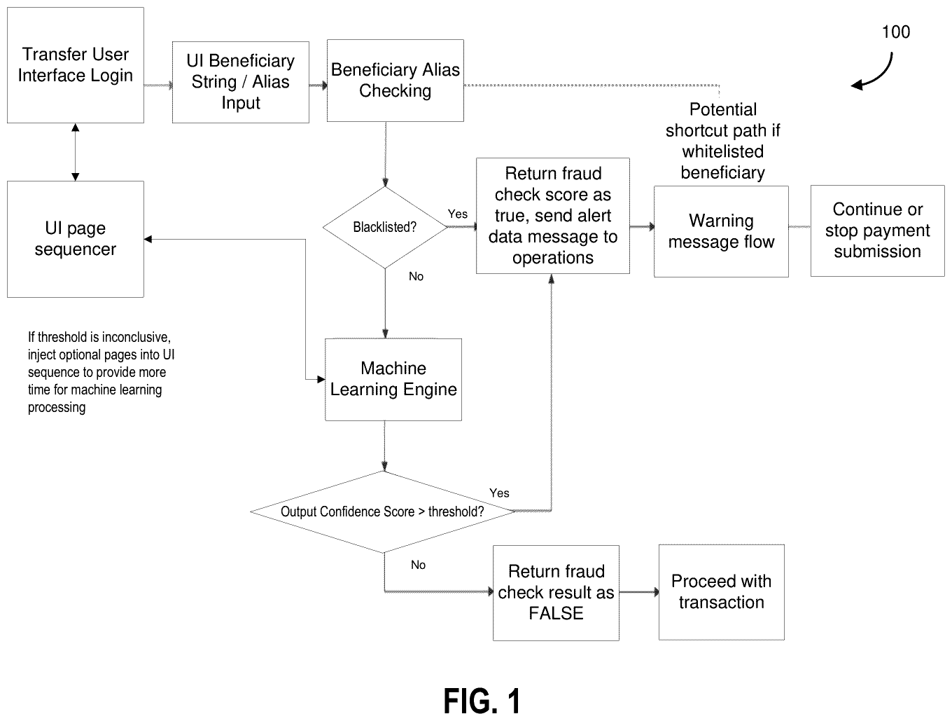

FIG. 1 is an example fraud checking process flow diagram, showing an example method for controlling a user interface to conduct a fraud check, according to some embodiments.

As noted herein, different levels of verification are possible. For example, if the beneficiary target address is found as an identical match on a whitelist database of trusted entities (e.g., other verified customers), no warning or processing is required. On the other hand, a blacklist may also be maintained where known malicious addresses or non-functional addresses are maintained, such that if there is an identical match, a warning or blocking signal is automatically invoked and the transaction is either not permitted to progress or a significant warning notification is required to be passed before the transaction can progress.

However, there are target addresses that are not on a whitelist or blacklist, and for those target addresses, a trained machine learning model is maintained on a backend system based on a global corpus of payment history data. In this example, the system is configured to send a data message corresponding to the payment request to generate a machine learning output data structure representative of a confidence score of fraudulent possibility. If the confidence score equals to or is higher than the threshold value preset by a fraud team, it means the payment is in high fraudulent risk, and the system will return the checking result as ‘TRUE’ to the payment channel (Move Money or Digital Connect) to indicate that further steps are required to be invoked.

The system can be configured for different types of rejections, including a soft rejection based on a soft classification, and a hard rejection based on a hard classification. For a soft rejection, the fraudulent cases will only be recorded in the system, and user won't be reported the fraud checking result and can still proceed the payments even for fraudulent cases. There is no warning message displayed to users. For a hard rejection, If any transactions in user's file was detected as fraudulent, those transactions will be blocked by and reported to users in an ACK letter or message.

In this example, a threshold setting can be for different learning machine learning models that are in use, each having their own threshold setting. The output can be continuously refined during inference as additional models are added to the inspection pipeline. In an example pipeline, there can be a UK machine learning model, then a Mexico machine learning model, and then a “rest of the world” machine learning model, having example thresholds of 0.7, 0.9, and 0.7, respectively. In some embodiments, the inspection pipeline begins with machine learning models sequenced in priority order, such as machine learning models that are local or related to regulatory compliance, and then additional add-on models are utilized if there is available time (e.g., a model specifically configured for estimating typographical errors).

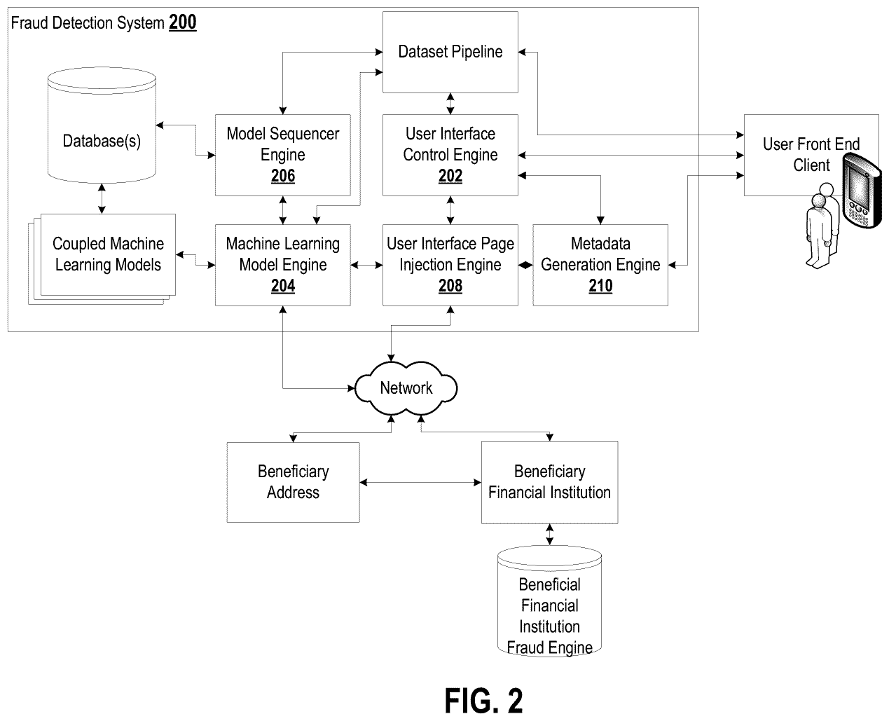

FIG. 2 is a block schematic diagram showing an example schematic of a proposed user interface/machine learning coupled backend engine, according to some embodiments. The system 200 is the user interface/machine learning coupled backend engine where a graphical user interface engine 202 is configured for serving, rendering, and receiving user inputs in response to interactive interface element controls, and a backend machine learning model engine 204 is configured to process incoming data messages and payloads against a series of machine learning models running in inference to generate classification outputs indicative of potential fraud. In an applied usage for a specific computing scenario, the specially configured graphical user interface rendering engine is a user interface engine that is configured to serve/host a webpage or user interface pages of a mobile application, such as an online banking or payment application. A user may be providing as an input, a string of characters or numbers that is a target intended recipient of funds.

This is especially useful as an approach to untangle potential cybersecurity attack vectors associated with social engineering. For example, an existing, trusted contact, may have their device or account compromised, and indicate that their “account number changed”, changing the target account number or identifier to reroute funds instead to a fraudulent account target. This can occur, for example, in cybersecurity attacks where a user's account has been taken over, their two factor authentication mechanisms being taken over by SIM card swaps, among others, and these are sophisticated attacks where even the most vigilant customers may be vulnerable.

The backend machine learning model 204 is configured to receive this string of characters or numbers for backend processing to generate a classification as to whether the recipient alias is potentially fraudulent or an erroneous entry. This is especially important for transactions where the target counterparty is an alias email address, for large value transactions, or for crypto asset transactions where the target is a cryptographic address string where even a single mis-typed character may lead to an irretrievable transaction. The graphical user interface engine 202 is configured to invoke the backend machine learning model 204 during intermediate inputs by the user in the middle of a transaction flow, front-loading the initiation of the machine learning process to provide additional computing time for generating machine learning outputs. The additional computing time allows for more complex machine learning outputs to be generated using higher dimensionality or higher complexity machine learning model architectures. As described herein, if additional time is available, additional models can be sequentially utilized by model sequencer engine 206, such as using additional models from different jurisdictions (e.g., neighboring jurisdictions), previous snapshot models (e.g., T-1, T-2, T-3), and so on to improve the accuracy of the system 200 opportunistically using computational cycles that may become available during interface traversal.

In a variant embodiment, as the user provides additional information through subsequent user interface pages, for example, adding in details such as a nickname for the address, increased dimensionality is possible on the back-end machine learning, and the increased dimensionality can be used to refine or further update the baseline machine learning score.

For example, the graphical user interface engine 202 may be configured to serve a series of user interface webpage flows that are interlinked with one another such that a user has to progress through each page to arrive at a final transaction for confirmation. In a variant embodiment, based on an intermediate output generated by the system, an intermediate score may be generated that is used as a continuous risk assessment. Effectively, every action and every input can be used for a dynamic intervention if the risk assessment passes a threshold. A benefit of the proposed approach is that the approach evolves and adapts automatically as the machine learning models are trained and re-trained, without requiring explicit rules programming. This is an important benefit as an explicit rules based approach would fall behind in a cybersecurity complexity race against malicious users.

As the user first enters the address in a flow step earlier in the process before final transaction, an intermediate message is sent to the backend machine learning model. This can be triggered, for example, on a payment details page once a user has clicked a ‘Continue’ button. While the user is traversing other pages and entering other details, such as a payment amount, the machine learning process carries on in the background, and if the payment was classified (e.g., detected) as fraudulent, a warning pop-up window or other notification can be invoked, displaying a warning message. User can select to continue payment submission or return & revise payment details on the window. If user chose to continue the payment submission, warning messages can continue to be injected by user interface page injection engine 208, configured for displaying on every follow up screen to remind user of the fraud risk. In some embodiments, where the processing requires additional time to converge on a score, in some embodiments, user interface page injection engine 208 may be configured to generate and render additional intermediate pages, such as those showing offers from a financial institution, etc.

Where a warning message is indicated or if someone following a transaction has selected a “report fraud”, an item can be tagged as potentially fraudulent. Similarly, in a variant embodiment, the warning message is a selectable interactive prompt where the user can indicate if the suspected addresses is problematic or not (e.g., in the event of a typographical error). The tagging can be conducted by generating a metadata tag that is inserted into a corresponding data structure, which can be combined together with the alias as a separate relational database column entry, according to some embodiments. Periodically, all beneficiary aliases that are tagged as fraudulent/problematic can be utilized to generate a new dataset that is used for machine learning model retraining, or provisioning to a fraudulent operations review team that can confirm the tags before inclusion into the new dataset (which upon confirmation can also conduct an automatic recall message). The new dataset is automatically utilized for system retraining so that the system is periodically automatically adapted against new types of threats or errors. As an example, malicious users could start using similar-looking Unicode characters as mechanism to fool users into sending money to scam addresses. As these Unicode special character addresses become flagged, the retraining datasets that are automatically generated tune the machine learning model parameters to start inferring that these types of addresses are problematic during inference operation of the machine learning models.

In a variant embodiment, the system 200 includes a feedback processing/metadata generation engine 210, following human or automated review of the potentially fraudulent data object. As part of the review, a metadata tag can be appended, augmenting the data object with a new field indicative of the reviewer or reviewer system's determination (e.g., true/false positive or true/false negative). The reviewer or reviewer system's determination field in combination with the features of the data object can then be used to be incorporated into a training dataset or used for re-training in real time of the backend machine learning model 204 so that the system can be automatically adaptive to changes in user/fraudster behavior without having such rules being explicitly programmed as static rules.

The system 200 can be configured to batch a series of fraud determinations together to periodically form re-training data sets for incrementing or iterating through the backend machine learning model 204 to generate a newer snapshot trained version of the backend machine learning model 204. By batching fraud determinations together, this allows the system to evolve by epochs and also allows potential rolling back of problematic versions to earlier iterations of the backend machine learning model 204.

When the machine learning engine is be trained on global transactions and a wider corpus of transaction data, and trained across business lines, or even different financial institutions the trained representation can be used as a strong proxy for estimating fraudulent or erroneous changes. For example, training sets that are used for a particular customer at a particular institution can be used to generate machine learning updates, and not maintained/discarded after generating parameter updates for training to maintain customer privacy. Multiple institutions or multiple lines of business can benefit from interactions with the globally maintained trained machine learning model.

An explicit rules engine may also be utilized in conjunction with the machine learning coupled backend engine that is utilized for tracking specific conditions, such as blacklist, whitelist, expert system/rule based logic, or beneficiary data that is used as an additional step.

In some embodiments, the system also includes a counterparty financial institution reporting engine that is configured to automatically generate a dataset or alert if the beneficiary's financial institution is known to indicate that this beneficiary was identified as potentially fraudulent. In this message to a counterparty financial institution, in some embodiments, to protect client privacy, simplified, redacted or obfuscated information is sent, for example, only the machine learning model confidence score or interval, without any information of the desired transaction that was prevented or reversed.

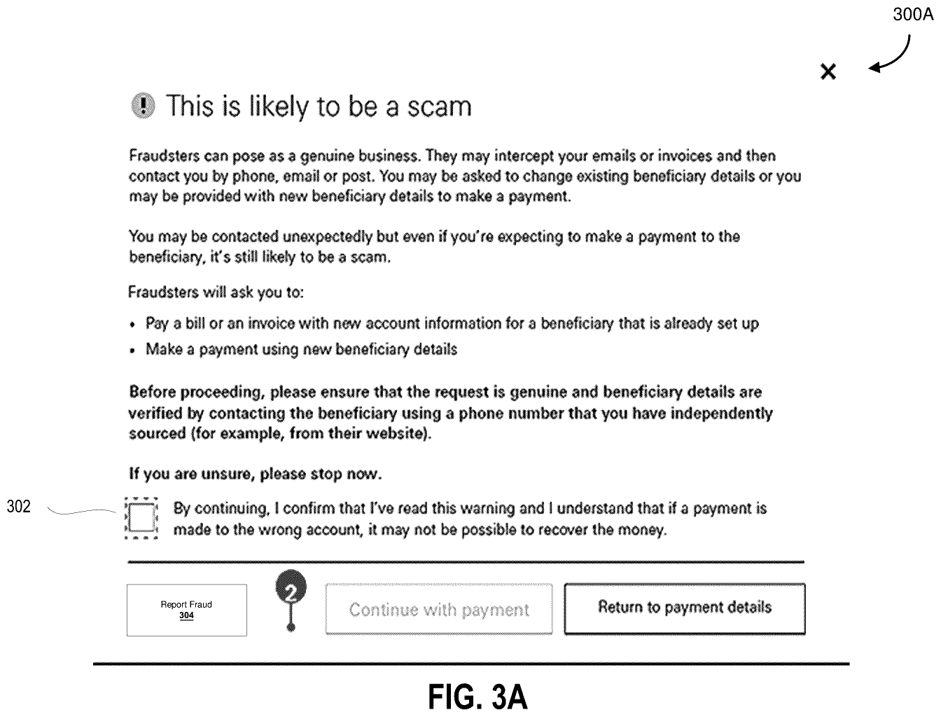

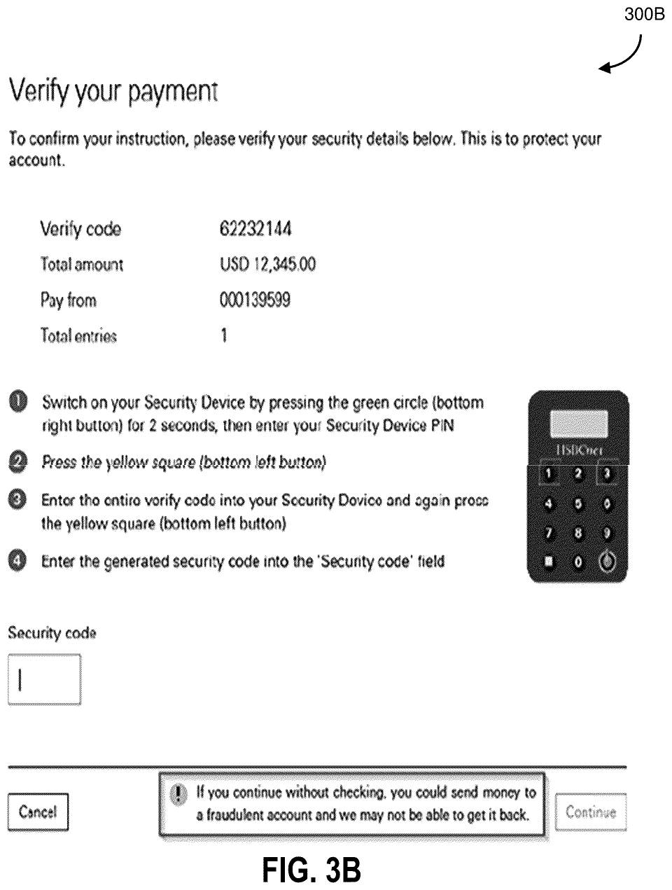

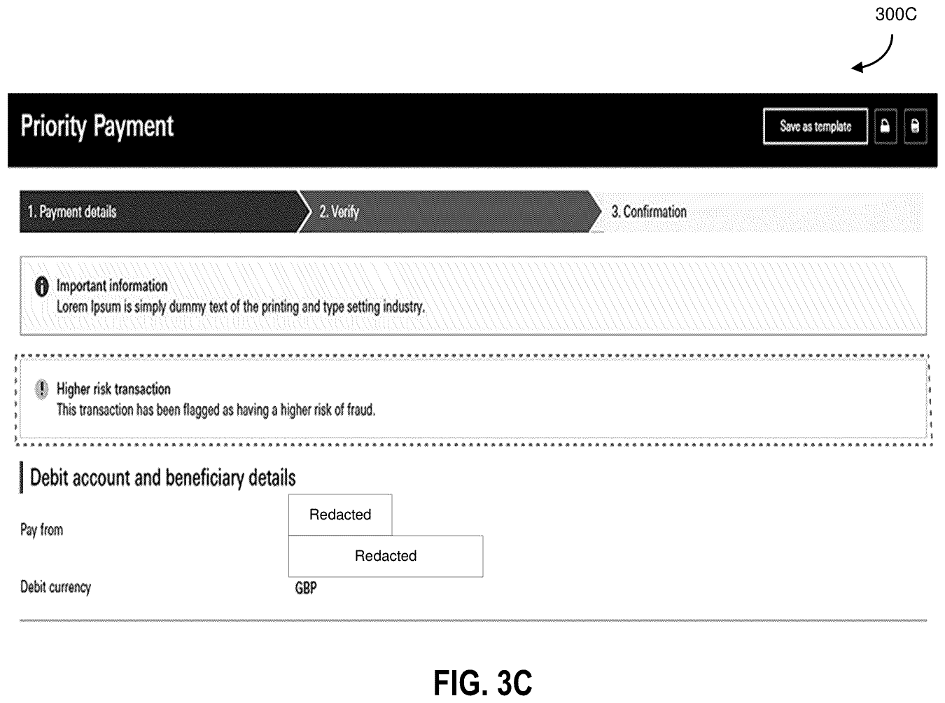

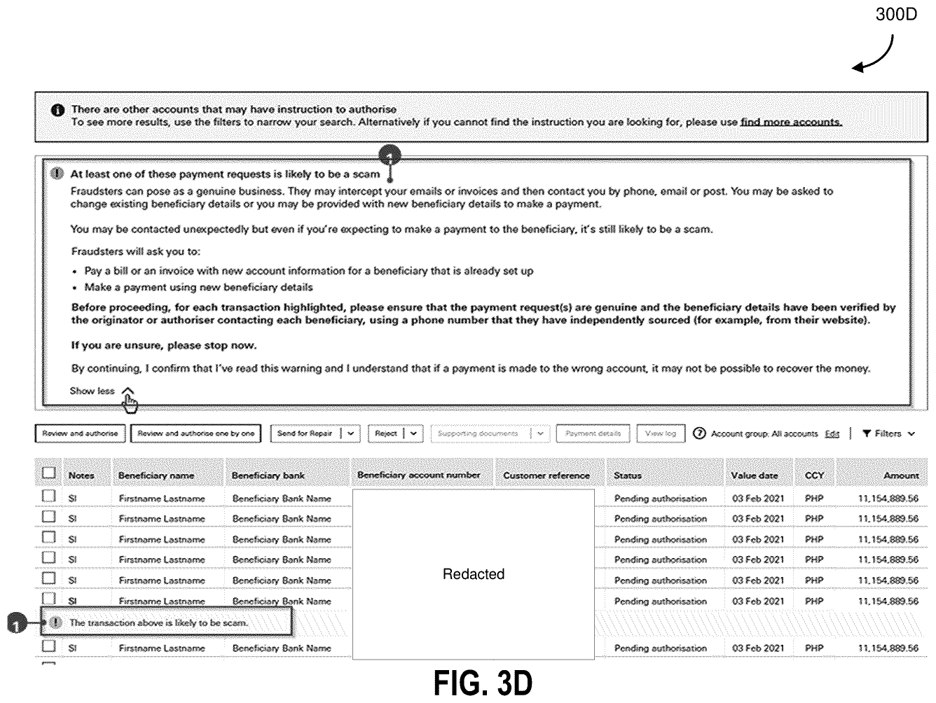

FIG. 3A, FIG. 3B, FIG. 3C are example user interface pages showing example messages, according to some embodiments. FIG. 3D is an example page showing an authorization page where the classification has indicated that a particular target beneficiary address is in a classification tier where it is flagged as a potential scam.

Because the machine learning process functions are invoked during intermediate user interface inputs instead of during a final confirmation or message transmission, the machine learning can begin earlier to obtain additional processing time, so that either an alert or classification can be made during the traversal of other steps of the user interface flow or during final confirmation of the message transmission. At FIG. 3A, the example user interface page 300A is shown during an intermediate (e.g., before confirmation) page as the system 100 has already generated a machine learning output indicative of potential fraud. The fraud page may be in the form of a modal window as shown in 300A, having an interface element 302 where the user can proceed anyways if selected. This interface element and its corresponding GET/POST interaction may be logged on the backend system as a metadata flag indicative of potential fraud or otherwise. For example, in this case, if the user selects to proceed anyways, the user may have re-checked the alias/address and confirmed that is indeed correct, and the alias/address can be added to a retraining dataset indicative of items that the model had flagged as potentially fraudulent but were not (i.e., a false positives dataset). In some embodiments, FIG. 3A has additionally a button for explicit reporting a fraud, which similarly, the corresponding GET/POST interaction may be logged on the backend system as a metadata flag indicative of potential fraud.

FIG. 3B is an example interface page 300B that shows an example higher escalation page that can be generated where a higher threshold is met, requiring not only that the user confirm, but they must also interact with a visual security element and another device (in this example, the user's two factor authentication security device) to confirm. This can be for potential transactions that the systems flags with a high confidence of being problematic. Similarly, if the user selects to proceed anyways, the user may have re-checked the alias/address and confirmed that is indeed correct, and the alias/address can be added to a retraining dataset indicative of items that the model had flagged as potentially fraudulent but were not (i.e., a false positives dataset).

FIG. 3C is an example interface page 300C that shows an another example that can be surfaced and rendered during a final confirmation page, according to some embodiments. In this example, the user is given a final notice before the user may elect to proceed with the transaction. When the user elects to proceed, a payment message is generated for processing. The payment message can include a number of fields in a data payload, such as UserId, CUSTID, debitAccNumber, DebitAccountCountry, payType; paySubType; payValueDate; BankIdValue; beneAccName; beneAccNumber; amount; currency; beneBankLocation; bankIdType; JRN;

transactionId, among others. There can be many more fields and higher dimensionality.

A machine learning engine backend is a useful mechanism as it can be trained to classify incoming target address strings as fraudulent or in error, without having to explicitly program classification rules. However, more complex machine learning engine backends can be slow in operation as large amounts of computing and processing power are required for processing highly complex architectures (e.g., multiple layers) or models having a large number of features. This complexity quickly scales upwards and has a proportionate impact on overall processing time for a given amount of computing resources. On the other hand, more complex models and model architectures are desirable as their machine learning accuracy and pattern recognition capabilities also scale upwards. For example, models may include LSTM type layers which are adapted improved machine learning memory.

Following a positive or inconclusive determination, a processing function can be automatically invoked to generate, for example, an alert data message to a fraud operations team for further monitoring and/or follow up. The alert data message can be provided in the form of a MIME (email), and can have a data payload including details of the machine learning object to be examined by the fraud operations team.

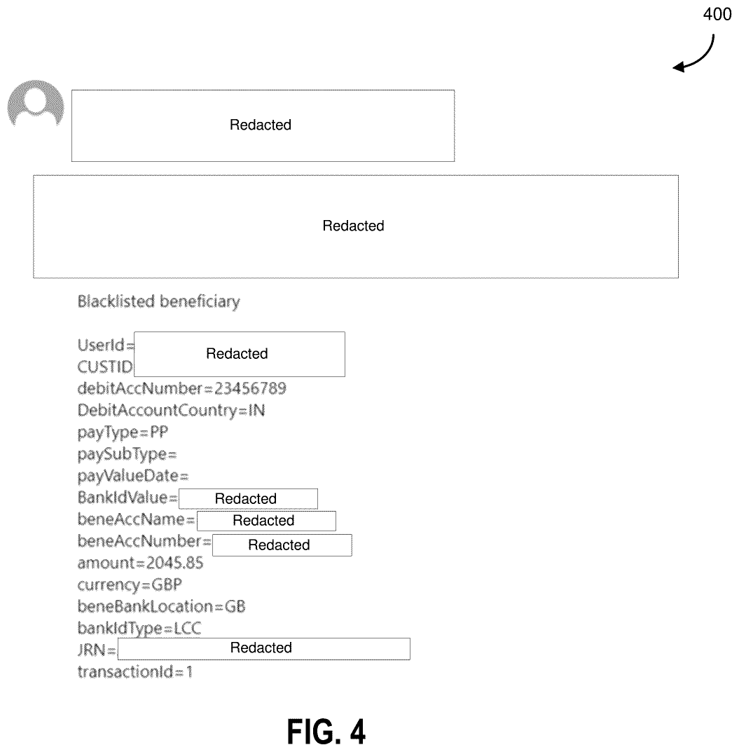

FIG. 4 shows an example email data object that can be generated where the payload is captured in the body of the email. In this example, this data payload includes a series of items that can consolidated into a data object for entering into the re-training dataset. This can be processed by the feedback processing engine 206, following human or automated review of the potentially fraudulent data object.

Each of these fields can represent a dimension of the record that is made, and further, as part of the review, a metadata tag can be appended, augmenting the data object with a new field indicative of the reviewer or reviewer system's determination (e.g., true/false positive or true/false negative). This new field can be an additional dimension to the data object, for example, adding an additional column as a classification label, which is then incorporated into a training dataset or used for re-training in real time of the backend machine learning model 204.

This allows the system to be automatically adaptive to changes in user/fraudster behavior without having such rules being explicitly programmed as static rules. In an example system that is re-trained in real or near-real time by generating a training pipeline for continuous retraining, the machine learning models data architecture can be configured to attach greater weight to the more recent examples so that the system becomes more attuned and adaptive to recent attack pattern types. However, a potential drawback of this approach would be that the system would be more prone to forgetting old attack patterns.

In some embodiments, instead of real or near-real time re-training, the system instead batches a series of fraud determinations together to periodically form re-training data sets for incrementing or iterating through the backend machine learning model 204 to generate a newer snapshot trained version of the backend machine learning model 204. Periodic snapshots can be made, and in some embodiments, prior snapshot models can be used for processing if additional time is left over as the user traverses through the user interface flow. For example, after processing is conducted using the latest trained model (T=0), a model snapshot T-1 can be used, and then T-2, etc., to assist in tracking patterns that may have been forgotten in model T=0.

Furthermore, by batching fraud determinations together, this allows the system to evolve by epochs and also allows potential rolling back of problematic versions to earlier iterations of the backend machine learning model 204. A benefit of using chained model T-1, T-2, etc., is that if old patterns that have been forgotten are used again, those models may catch those transactions, and when added back into the re-training pipeline, the model T=0 is updated again to track those patterns, increasing their recency and the ability of model T=0. Accordingly, a technical contribution of chaining old models onto the processing workflow is that the system can be automatically hardened against forgetting, which is a useful approach especially if the model storage is limited, which makes the models prone to forgetting as a technical deficiency. In this example, the system can take advantage of increased time for slower users to enhance the system's ability for faster users.

Another type of additional model includes third party models and processing that can be conducted as between financial institutions. In this example, a counterparty bank trained model can be accessed through a secure API, or provided periodically as between banks in a special computing silo so that suspicious beneficiaries can be tracked at an interbank level.

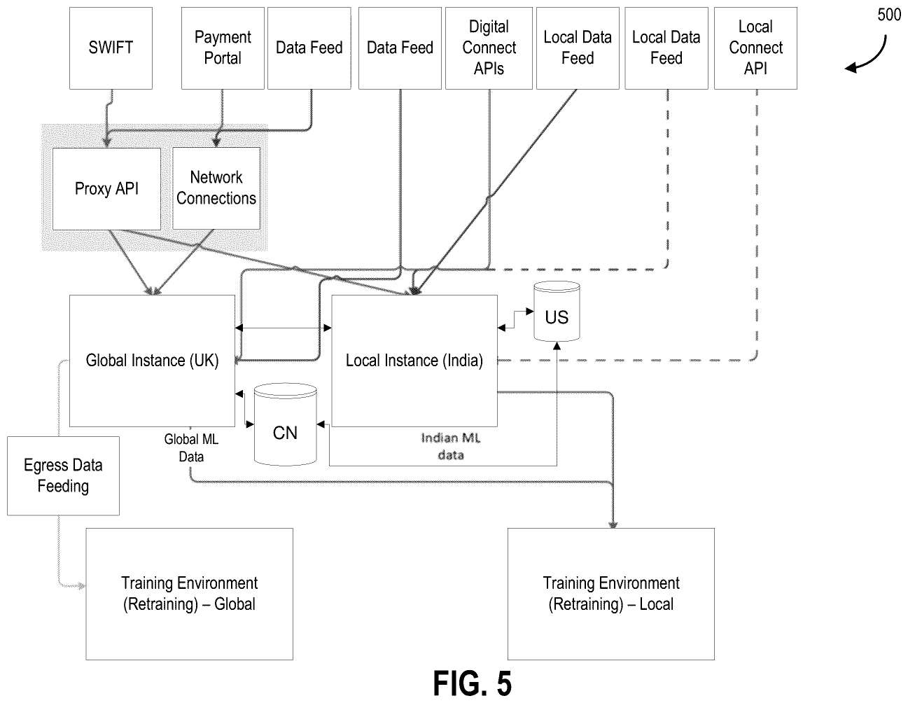

FIG. 5 is an example machine learning engine backend that is trained on a corpus of incoming training data sets, according to some embodiments. The machine learning engine backend in this example includes both a shared model and a local model that is maintained across different customer silos of a single institution, or across multiple financial institutions. Using this type of shared model that is periodically trained is especially useful because it can be trained to classify incoming target address strings as fraudulent or in error, without having to explicitly program classification rules.

When the machine learning engine is be trained on global transactions and a wider corpus of transaction data, and trained across business lines, or even different financial institutions the trained representation can be used as a strong proxy for estimating fraudulent or erroneous changes. For example, training sets that are used for a particular customer at a particular institution can be used to generate machine learning updates, and not maintained/discarded after generating parameter updates for training to maintain customer privacy. Multiple institutions or multiple lines of business can benefit from interactions with the globally maintained trained machine learning model. An additional model that may be included in the pipeline is an additional model based on the user's history that can be used as a scalar factor to scale the risk for the transaction. If the beneficiary has a history of receiving payments from this user or other users, those aspects can also be combined together in this additional model for generation of a holistic risk. The user's history can also include other information for prior transactions for the particular user, such as third party risk scores, and information such as tracked device login details, locations, among others.

During initial testing of an example embodiment of the system, the was able to achieve initial determinations at approximately 300 ms, and in view of round trip communications, the total determination approach for an initial determination required up to 700 ms. With respect to the additional model based on beneficiary and user risk, in some embodiments, the system automatically maintains this information (e.g., previously obtained third party risk scores) in a cache memory to reduce a total latency required to communicate with third party systems.

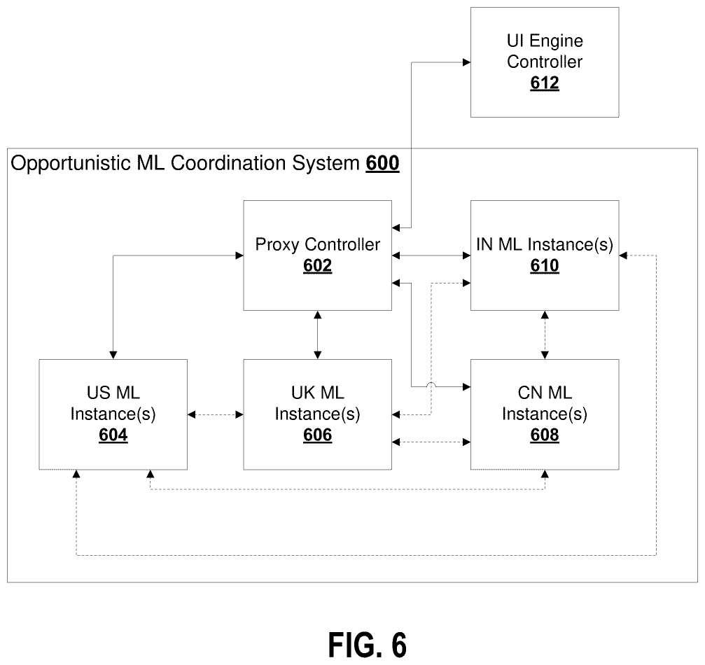

FIG. 6 is an example proxy controller that is directly coupled to one or more machine learning processing engines, each of which have local trained machine learning instances for a local jurisdiction or domain usage, according to some embodiments.

As noted herein, the level of verification of the target beneficiary identifier can be opportunistically increased as more processing time is available, and in some embodiments, may also include using a proxy controller that is configured to securely and privately connect to different machine learning instances that are walled from communicating from one another directly to conduct increasing levels of machine learning based verification if more time is available.

An example opportunistic ML coordination system 600 is shown in FIG. 6. In this example, a UI engine controller 612 that can be coupled to the user interface control engine 202. In a practical implementation, this UI engine controller 612 can be either part of the front-end client (e.g., the user's mobile device and the mobile application running thereon) or a part of a back-end web server operating a model-view-presenter/model-view-controller user interface patterns, where the presenter/controller module is executing state changes to a backend state model representing the user's journey through the user interface through a view module that is coupled to the front-end client.

The state changes in the user interface are controlled and configured such that at an earlier, non-final user interface page that is generated, the user inputs, into an input field, the target beneficiary's alias that serves as a unique identifier for where the transaction should send money to, for example.

The UI engine controller 612 is configured to track how far a user is along a user interface journey and estimate an amount of processing time available for background processing. The UI engine controller 612 can pass information in the form of data messages indicating, for example, that the user is on page 3 of 12 total screens, and thus backend ML processing can continue. When a baseline amount of ML processing (e.g., at the local model) is completed, this can be flagged by the proxy controller 602 and the proxy controller 602 can begin opportunistically conducting additional background verification against the instance. For example, during available processing time, additional instances can be recruited for opportunistically increasing the robustness of analysis by chaining together a processing pipeline.

In this example, different instances (US 604, UK 606, CN 608, and IN 610) can be configured for chained operation by proxy controller 602 to conduct individual machine learning predictions for estimating whether a particular beneficiary alias is potentially problematic using relevant information (whitelists of beneficiaries, blacklists of beneficiaries, IP, device fingerprints, rules, models). This information can be used making decisions for the payments sent to them or from them. This approach and architecture can help with data localization requirements in multiple countries (data belonging to that country must remain in that country), the decision making is distributed to a certain extent while also sharing pertinent information.

Each of these additional determinations can be used to potentially block the beneficiary address. For example, if a user is sending money to an address in the United States, the beneficiary address may not be detected as a suspicious address in the US machine learning instance (or as described earlier, a chained version of US instances and earlier snapshots). However, if additional time is available (e.g., the user is still on an earlier UI page that is far from the final confirmation page), the UI engine controller 612 indicates that additional time is available, and sends a data message to the proxy controller 602 which begins automatically recruiting and analyzing the address using the UK instances 606, building an opportunistic processing pipeline by chaining additional instances or earlier snapshots, or a combination of both (e.g., in a breadth first or a depth first or combination manner thereof). In some embodiments, the approach can also include load distribution where a load is shared across different instances (subject to regulatory requirements), where other instances take up the processing load when one instance fails or is overloaded.

The proxy controller 602 is the entry point to all the instances and will route the request for a decision to the most appropriate instance and then forward the decision back to the calling application. When the UI engine controller 612 indicates that the user is nearing the final state flow (where the user interacts with the user interface element on the final screen that acts as the final confirmation to send the funds), in some embodiments, the proxy controller 602 is configured to stop adding additional processing into the processing pipeline, and upon the completed processing by the last machine learning node in the processing pipeline, a final result value is provided back to the UI engine controller 612.

The final result value, in an example, indicates that if any trained machine learning model indicated that the beneficiary address was suspicious greater than a threshold, and if so, would either require additional verification, additional user interface pages to be rendered, flags the transaction, or in some cases, blocks the transaction entirely. In some embodiments, the proxy controller 602 is configured with an element of randomness in ML instance selection and the order in which opportunistic machine learning is added to the processing chain (e.g., using a random number generator to rank the available machine learning models). A technical benefit of random selection and ranking is that the processing becomes harder for a malicious user observing the system to decode the approach. Finally, a technical benefit of applying layered opportunistic approaches as described herein is that once a malicious beneficiary is flagged during a particularly slow user session, it can be immediately added to a blacklist to benefit faster user sessions.

In another variation, the computer processing instances can also be separated into payment types, instead of by country. The system can also be polymorphic, whereby different instances with different purposes can be opportunistically chained together to run additional types of verifications against the beneficiary identifier. In this example, the proxy controller 602, instead of identifying other country ML instances to recruit, begins recruiting ML instances from other domains as well. For example, while the main described use case for transactions fraud monitoring, additional instances can be used for AML (Anti-Money Laundering), counter-terror financing, identifying mule accounts, creating a network of connected (fraudulent) parties, or detecting anomalies in any type of data set. Accordingly, the system is able to utilize otherwise dormant processing time to conduct additional background machine learning processing by coupling to additional models.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

As can be understood, the examples described above and illustrated are intended to be exemplary only.

1. A computer system for controlling operation of a graphical user interface using a machine learning based fraud detection engine, the computer system comprising:
a computer processor operating in conjunction with computer memory and a non-transitory data storage, the processor configured to:
receive, as an intermediate webpage input on an intermediate graphical user interface screen, a string identifier of a target counterparty for a transaction, the intermediate webpage input being provided in an interactive graphical user interface control element provided before a user provides a confirmation input on a final graphical user interface screen;
in a duration of time while the user is traversing is traversing the intermediate graphical user interface screen and subsequent graphical user interface screens before the user provides the confirmation input, provide the string identifier for processing using one or more trained machine learning model data architectures operating in an inference mode to generate one or more classification logit output values indicative of a potential fraud or error classification, the one or more trained machine learning model data architectures configured to incrementally refine the one or more classification logit output values during the duration of time;
prior to processing the confirmation input, if the one or more classification logit output values are greater than a threshold, automatically block the transaction to the target counterparty.

2. The system of claim 1, wherein the one or more trained machine learning model data architectures include a plurality of different trained machine learning model data architectures that are configured to operate sequentially during the duration of time, wherein each trained machine learning model data architecture of the plurality of different trained machine learning model data architectures contributes to the one or more classification logit output values.

3. The system of claim 2, wherein the plurality of different trained machine learning model data architectures include at least a first local trained machine learning model data architecture and a second regional trained machine learning model data architecture, the string identifier of the target counterparty for the transaction being processed first using the local trained machine learning model data architecture and subsequently, the second regional trained machine learning model data architecture during the duration of time if there is a remainder of time following processing by the local trained machine learning model data architecture.

4. The system of claim 3, wherein the local trained machine learning model data architecture is trained using a different dataset than the second regional trained machine learning model data architecture.

5. The system of claim 3, wherein the processor is configured to determine that processing using a trained machine learning model data architecture to iteratively update the one or more classification logit output values is reaching a steady or equilibrium state, and upon a positive determination, the processor is configured to instantiate a next regional trained machine learning model data architecture to continue iteratively update the one or more classification logit output values.

6. The system of claim 5, upon receipt of the confirmation input on the final graphical user interface screen, the determination of whether the one or more classification logit output values is reaching the steady or the equilibrium state is conducted on a most recent trained machine learning model data architecture being utilized, and upon a positive determination that the one or more classification logit output values have not reached the steady or the equilibrium state, delay processing of the confirmation input on the final graphical user interface screen until either the one or more classification logit output values have reached the steady or the equilibrium state or a pre-determined timeout duration has elapsed.

7. The system of claim 6, wherein the delay of the processing of the confirmation input is conducted through insertion of one or more additional confirmation screens into the graphical user interface flow.

8. The system of claim 5, wherein following processing of the confirmation input on the final graphical user interface screen, the system continues to iteratively update the one or more classification logit output values using all available trained machine learning model data architectures, and upon the one or more classification logit output values being determined to be greater than the threshold, flag the transaction to the target counterparty.

9. The system of claim 1, wherein if the one or more classification logit output values are greater than the threshold, a data message is automatically sent to a financial institution computing system related to the target counterparty.

10. The system of claim 1, wherein the computer system is a special purpose machine residing in a data center and coupled to one or more dataset pipelines and configured for continuous retraining of the one or more trained machine learning model data architectures, the computer system coupled to a message bus and receiving requests for inference from the message bus and transmitting interface control commands across the message bus to a user interface controller coupled to a front end client rendering the graphical user interface.

11. A computer method for controlling operation of a graphical user interface using a machine learning based fraud detection engine, the computer method comprising:
receiving, as an intermediate webpage input on an intermediate graphical user interface screen, a string identifier of a target counterparty for a transaction, the intermediate webpage input being provided in an interactive graphical user interface control element provided before a user provides a confirmation input on a final graphical user interface screen;
in a duration of time while the user is traversing is traversing the intermediate graphical user interface screen and subsequent graphical user interface screens before the user provides the confirmation input, providing the string identifier for processing using one or more trained machine learning model data architectures operating in an inference mode to generate one or more classification logit output values indicative of a potential fraud or error classification, the one or more trained machine learning model data architectures configured to incrementally refine the one or more classification logit output values during the duration of time;
prior to processing the confirmation input, if the one or more classification logit output values are greater than a threshold, automatically blocking the transaction to the target counterparty.

12. The method of claim 11, wherein the one or more trained machine learning model data architectures include a plurality of different trained machine learning model data architectures that are configured to operate sequentially during the duration of time, wherein each trained machine learning model data architecture of the plurality of different trained machine learning model data architectures contributes to the one or more classification logit output values.

13. The method of claim 12, wherein the plurality of different trained machine learning model data architectures include at least a first local trained machine learning model data architecture and a second regional trained machine learning model data architecture, the string identifier of the target counterparty for the transaction being processed first using the local trained machine learning model data architecture and subsequently, the second regional trained machine learning model data architecture during the duration of time if there is a remainder of time following processing by the local trained machine learning model data architecture.

14. The method of claim 13, wherein the local trained machine learning model data architecture is trained using a different dataset than the second regional trained machine learning model data architecture.

15. The method of claim 13, wherein the processor is configured to determine that processing using a trained machine learning model data architecture to iteratively update the one or more classification logit output values is reaching a steady or equilibrium state, and upon a positive determination, the processor is configured to instantiate a next regional trained machine learning model data architecture to continue iteratively update the one or more classification logit output values.

16. The method of claim 15, upon receipt of the confirmation input on the final graphical user interface screen, the determination of whether the one or more classification logit output values is reaching the steady or the equilibrium state is conducted on a most recent trained machine learning model data architecture being utilized, and upon a positive determination that the one or more classification logit output values have not reached the steady or the equilibrium state, delay processing of the confirmation input on the final graphical user interface screen until either the one or more classification logit output values have reached the steady or the equilibrium state or a pre-determined timeout duration has elapsed.

17. The method of claim 16, wherein the delay of the processing of the confirmation input is conducted through insertion of one or more additional confirmation screens into the graphical user interface flow.

18. The method of claim 15, wherein following processing of the confirmation input on the final graphical user interface screen, the method further comprises iteratively updating the one or more classification logit output values using all available trained machine learning model data architectures, and upon the one or more classification logit output values being determined to be greater than the threshold, flag the transaction to the target counterparty.

19. The method of claim 11, wherein if the one or more classification logit output values are greater than the threshold, a data message is automatically sent to a financial institution computing system related to the target counterparty.

20. A non-transitory computer readable medium storing machine interpretable instructions, which when executed by a processor, cause the processor to perform a computer implemented method for controlling operation of a graphical user interface using a machine learning based fraud detection engine, the computer implemented method comprising:
receiving, as an intermediate webpage input on an intermediate graphical user interface screen, a string identifier of a target counterparty for a transaction, the intermediate webpage input being provided in an interactive graphical user interface control element provided before a user provides a confirmation input on a final graphical user interface screen;
in a duration of time while the user is traversing is traversing the intermediate graphical user interface screen and subsequent graphical user interface screens before the user provides the confirmation input, providing the string identifier for processing using one or more trained machine learning model data architectures operating in an inference mode to generate one or more classification logit output values indicative of a potential fraud or error classification, the one or more trained machine learning model data architectures configured to incrementally refine the one or more classification logit output values during the duration of time;
prior to processing the confirmation input, if the one or more classification logit output values are greater than a threshold, automatically blocking the transaction to the target counterparty.
